(19) United States
(12) Patent Application Publication
(10) Pub. No.: US 2011/0274598 A1
(43) Pub. Date: Nov. 10, 2011

(54) SUSTAINABLE RECOVERY OF METAL COMPOUNDS

(76) Inventor: James R. Akridge, Tucson, AZ (US)

(21) Appl. No.: 12/937,710

(22) PCT Filed: Apr. 14, 2009
(86) PCT No.: PCT/US2009/040578

§ 371 Date: Dec. 29, 2010

Related U.S. Application Data
(60) Provisional application No. 61/044,877, filed on Apr. 14, 2008.
(60) Provisional application No. 61/044,878, filed on Apr. 14, 2008.
(60) Provisional application No. 61/044,898, filed on Apr. 14, 2008.

(51) Int. Cl. C01G 55/00; C01G 5/00; C01G 7/00; C01G 3/02; C01G 3/08; C01G 45/02; C01G 45/08; C01G 30/00; C01G 28/00; C01G 21/02; C01G 21/18; C01G 19/02; C01G 19/00; C01G 13/02; C01G 13/00; C01G 11/00; C01G 9/02; C01G 9/00; C01F 7/02; C01F 7/66; C01F 5/38; C01F 5/02; C01F 3/02; C01F 3/00; C01G 53/04; C01G 53/00; C01G 49/02; C01G 49/00; C01G 15/00; C01F 11/38; C01F 11/02; C01B 21/48; C22B 15/00; C22B 11/00; C01B 13/36

(52) U.S. Cl. 423/22; 423/1; 423/34; 423/35; 423/50; 423/87; 423/92; 423/95; 423/101; 423/122; 423/125; 423/143; 423/158; 423/162; 75/711

(57) ABSTRACT

Disclosed is a process for removing metals from waste, particularly electronic waste (or “e-waste”). The process generally includes the steps of dissolving at least some of the metals from the waste with nitric acid reagent and then causing at least some of the metals to precipitate as metal oxides and/or metal nitrates. NOx gases produced as by-product by the nitric acid dissolution of metallic components in the electronic waste are reused, in particular for generating permanganate when one of the metallic components comprises manganese.

### CROSS REFERENCE TO RELATED APPLICATIONS

The present invention relates to reclaiming materials from waste and claims priority to and incorporates by reference each of U.S. Provisional Applications 61/044,877, 61/044,878 and 61/044,898.

### BACKGROUND

Electronic devices and batteries represent a substantial yearly tonnage of use of metals, metal oxides, plastics, glass, and other materials. Metals of the 3d, 4d, 5d transition series and their oxides are used considerably in these applications. For example, computer monitors can contain lanthanide series oxides used as phosphors coated on the glass surface. Flat panel display devices can contain gold, silver, nickel and platinum in the circuit boards and chips. Also, some electronic devices, such as fluorescent lights, in addition to the phosphor coatings on the interior surface of the glass, contain mercury and therefore cannot lawfully be placed in landfill. Mercury can be toxic if it leaches into groundwater or if it contaminates soil, and has value as a raw material if recovered.

Recovery/recycling (instead of disposal) of electronic devices and spent primary and secondary batteries presents an opportunity for governmental bodies and private industry throughout the world because of the vast amount of waste and the lack of an effective and financially-viable recovery process. The metals contained in electronic scrap and battery scrap are valuable commodities if they could be efficiently and effectively recovered. Landfill disposal is increasingly unacceptable not simply because of the loss of valuable metal that could be recovered, but also because of the contamination of soil and ground water due to the leaching of contaminants into the soil or ground water. Further, as previously mentioned, especially-hazardous materials such as mercury-containing scrap often cannot be disposed in landfills under current law.

Common methods to recover metals from primary alkaline and carbon/zinc batteries is to recycle them by either (1) using them as feed in an electric arc furnace, or (2) dissolving them in sulfuric acid to ultimately obtain metal sulfates. Metal sulfates and sulfites themselves are generally not usable and must be converted into metal oxides or carbonates. Thus, sulfates or sulfites must preferably be further processed to be most useful as chemical feed for chemical industries.

Electronic devices, such as computers, computer terminals, radios, VCR players, DVD players, CD players, and cellular telephones, present a somewhat more complex waste issue (all of such devices, other waste electronic devices and waste batteries are collectively referred to herein as “e-waste”) because of the numerous types of devices, the immense physical volume of the devices, the various types of metal used in the various types of devices, and the large volume of each device compared to the amount of metal to be recovered from the device. A known method for recycling electronic devices is disassembly to extract the most valuable metal-containing components, and refurbishing them reuse for those devices that can be recycled in this fashion. When disassembled, the various parts are stripped, sorted into common piles and then each type of scrap is shipped to a recycler specializing in disposing of, or reclaiming, that type of scrap.

This disassembly of e-waste requires a massive amount of manual labor and exposure of workers to toxic metals in the e-waste. The current methods for recovery also either (1) do not fully reclaim the valuable metal from the e-waste, (2) destroy the inherent high purity of the metal in the e-waste, (3) lead to heavy metals being placed in landfills since low-value components are unprofitable to recycle and are placed in landfills, or (4) (in the case of battery recovery) often result in the use of sulfuric acid, which creates substantial insoluble hazardous by-products, which themselves must usually be further processed into an oxide or carbonate, for reuse.

Non-oxidizing mineral acids such as sulfuric acid, phosphoric acid, and hydrochloric acid are all non-oxidizing mineral acids that can be used to dissolve transition metals. In doing so, they liberate hydrogen from the acid and require the continuous addition of more acid.

The use of nitric acid (a powerful oxidizing acid) as the dissolution agent for e-waste would have several advantages. First, many, if not all, metal nitrates formed by dissolution of the metals in nitric acid are soluble in the nitric acid. Second, the nitric acid dissolution of metals does not liberate hydrogen (with only few exceptions, and those exceptions do not, or rarely, include 3d, 4d or 5d transition metals or the lanthanide series, which are commonly found in e-waste) and thus does not destroy the acid in the manner described above.

A system according to the invention is designed to carry out one or more of the processes set forth herein and optionally includes one or more of a (1) permanganate-based solvent regeneration process and system, (2) zinc generation process and system, (3) SiO₂ particulate generating process, (4) process to grind waste plastic, and (5) process to resolubilize metal oxides and/or metal nitrates and precipitate metal oxides as pigments.

### SUMMARY OF THE INVENTION

The intent of the invention is to create a method to reclaim waste that includes metal, and most preferably e-waste, in a profitable manner. Nonmetallic waste (such as phenolic circuit boards, wire insulation bundles, electronic chips, etc.) can also optionally be destroyed and/or reclaimed as a clean raw material that can be returned to commercial use through utilization of the invention. Thus, the invention can recycle many metals, and optionally other materials, in essentially any type of waste.

The process and system of the invention may also incorporate a reclaim and reuse of the nitrous oxide liberated from nitric acid dissolution of components of the waste, thus regenerating the dissolution reagent nitric acid. To avoid the high cost of installation of the known Ostwald process (known to those in the art and defined below) for oxidation of nitrous oxides to nitrogen dioxide (which when subsequently dissolved in water yields nitric acid (HNO₃)), a process and system according to the invention could be coupled to or include a potassium permanganate manufacturing process/facility. Potassium (or sodium) permanganate (or any metal permanganate) may be used for reoxidation of the solvent decomposition products to regenerate nitric acid, as explained further below.

In summary the invention uses nitric acid to dissolve most metals (excluding gold and platinum, which can still be reclaimed utilizing the process of the invention) and destroys or cleans nonmetallic components that are placed in the nitric acid bath. The non-soluble but clean material, whether it be plastic, glass or any other material not dissolved by the nitric acid can be separated by filtration or other suitable method and reused or disposed. For instance, the glass generated by the recycling facility can be further sized, such as by grinding, for use as a road paving material. The metallic nitrates contained in solution in the nitric acid are selectively precipitated as oxides or carbonates by appropriate chemical treatment and can then be sold into commerce as metal oxides, carbonates or nitrates, or be further treated to create elemental metals in some cases.

As previously mentioned, the invention could also be used in conjunction with or as part of a potassium permanganate process. As way of background, potassium permanganate is typically prepared by extraction of natural Mn0₂ ore (pyrolucite), which is cleaned to remove gangue (mostly SiO₂), then ground to a very fine particle size, then reacted in molten KOH in the presence of oxygen and then subject to subsequent electrochemical oxidation to create potassium permanganate:

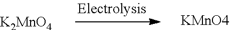

As previously mentioned, a process and system of the invention could also include or be coupled to a process and system used for manufacturing one or more of zinc phosphate, zinc orthophosphate or other zinc chemicals for the use in water treatment facilities, or in the manufacture of batteries. Zinc phosphates of various types are used for passivation of domestic drinking water delivery piping systems. Zinc also has uses in metallurgy (brass), medical as supplements for dietary use, as calamine (treat skin rash), water pipe treatment, and other commercial applications.

Primary alkaline and carbon zinc batteries, the most common consumer batteries globally, are about 70% or more by volume of combined manganese oxides (which can be used as the starting materials for preparation of potassium permanganate) and zinc metal and zinc oxides (which can be used as starting material for zinc chemicals for water treatment). Primary alkaline battery cells use about 40% KOH as electrolyte. Thus, coupling the process and system of the invention to a permanganate generating process and system and/or a zinc phosphate process and system would make sense because spent alkaline battery cells could provide a low cost and high purity source of raw materials (i.e., zinc oxide and manganese dioxide) for both processes.

Therefore, the use of the output of the permanganate facility, which is potassium manganate (the precursor to potassium permanganate) or potassium permanganate, may be used to regenerate (oxidize) the nitrous oxide resulting from the utilization of the nitric acid dissolution of metals (and optionally, non-metals) from waste and most particularly e-waste. The nitrous oxide is oxidized to nitrogen dioxide by permanganate or manganate. This oxidation of nitrous oxide results in the reduction of permanganate or manganate and generation of manganese dioxide as a by-product of the use of manganate or permanganate as the oxidizing compound. Manganese dioxide is the starting material for the manufacturing of potassium permanganate and/or potassium manganate manufacturing process. Therefore, nitrous oxide generated from the action of nitric acid on the e-waste and manganese oxides generated from the regeneration of nitrous oxides could be used as raw materials for the nitric acid and permanganate processes. Alternately, potassium permanganate reduced to potassium manganate by oxidizing NOₓ is a better starting material for the generation of potassium permanganate through electrolysis of potassium manganate generated from the oxidation of nitrous oxides.

Fluorescent lighting tubes of any type can also be recycled with the glass being cleaned for reuse or use in other processes in commerce. When the light bulb is placed in the nitric acid bath the resulting solution contains the metal phosphors (generally metals of the lanthanide series on the Periodic Table), the glass and the mercury. The metals (from the metal phosphors) and mercury can be precipitated and reused and the cleaned glass can be filtered from the nitric acid bath and reused.

### BRIEF DESCRIPTION OF THE DRAWINGS

FIG. 1 illustrates a recycling process of the present invention.

FIG. 2 illustrates another recycling process of the present invention.

FIG. 3 illustrates another recycling process of the present invention.

FIG. 4 illustrates another recycling process of the present invention.

FIG. 5 illustrates a system for recycling waste according to the invention.

FIG. 6 illustrates a system for recycling waste according to the invention.

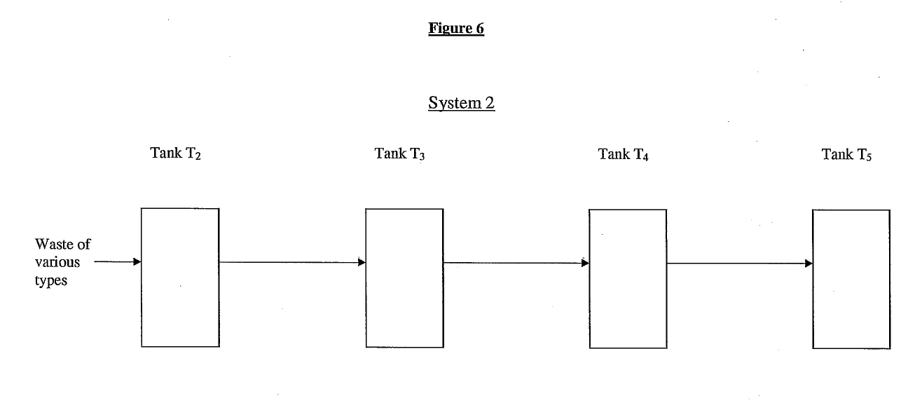

FIG. 7 illustrates a system for recycling waste according to the invention.

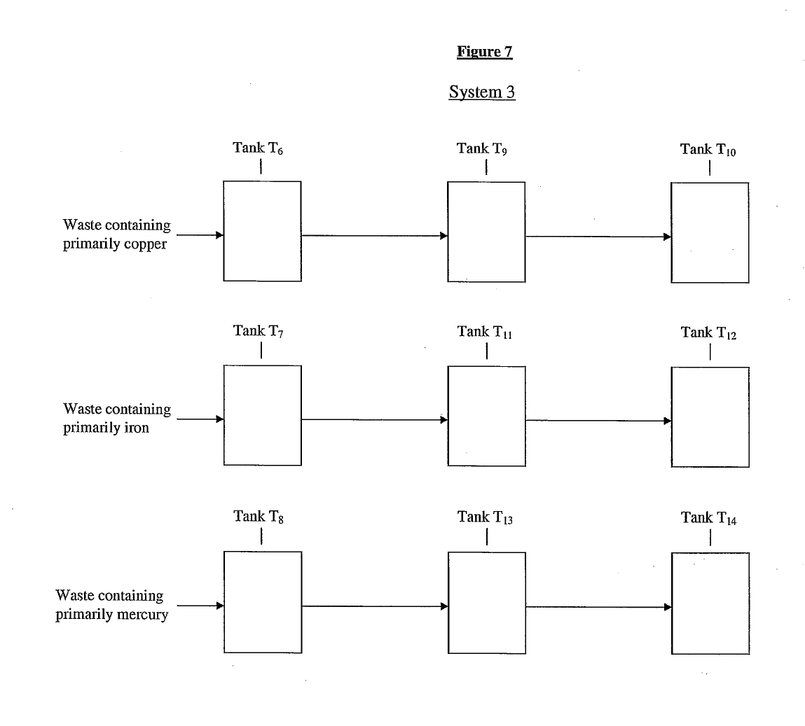

### DETAILED DESCRIPTION OF PREFERRED EMBODIMENTS

Preparation of permangante from natural ore (pyrolusite) is described by the following equation: 2e−+0₂+Mn0₂------->Mn0₄=[K₂MnO₄]. Continuous electrolysis of K₂MnO₄ is described by the following equation: 2[K₂MnO₄]+2H₂0------->2[KMnO₄]+KOH+H₂, wherein permanganate is produced at the anode. If we examine the electrolysis reaction and assume the reaction can be conducted in molten KOH then it may be possible to electrowin zinc metal at the cathode.

This invention can be extended to sodium permanganate by the use of NaOH to increase the pH of the bath.

In the nitric recycle, it is desirable to capture the nitrous oxide gas produced when organic material, any metal (the most commonly found in e-waste; copper, silver, lead, iron, gold, platinum, nickel, or tin) react. Nitrous oxide (NOx) is industrially oxidized to NO₂ via the Ostwald process. The Oswald process is normally fed with ammonia (NH₃) and uses Pt/Rd catalyst and thermal reaction to generate ultimately NO₂, which is then dissolved in water to form nitric acid.

### Basic Oswald Process

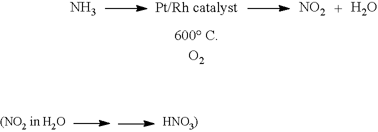

The Ostwald process is not a generally applicable process for regeneration of nitric acid from nitrous oxides generated from extraction of waste metals reacting with nitric acid. As it is highly probable that sulfur and sulfur compounds (or arsenic) would be contained in any waste stream (quite reasonably from organic matter contamination) and that sulfides, sulfates, sulfur dioxide would be generated by reaction with nitric acid and thus the gas exiting the dissolution reactor would have some sulfur or arsenic or other catalyst poison, the Ostwald catalyst would be poisoned because noble metals used as catalysts (Pt, Rd, Ru, etc. or combinations of these) preferentially react with sulfur and arsenic compounds thus destroying the catalytic action. The catalyst becomes ineffective in the Ostwald process if exposed to sulfur or sulfur containing material (or arsenic compounds). Therefore, though using the Ostwald process for regeneration of NO₂ from NOx is possible it is judged not practical because of the potential for sulfur compounds to be released in a recycle thus reacting with the Ostwald catalyst and shutting down the catalytic action. A recycle process according to the invention using the Ostwald process coupled to a nitric acid extraction process would be waste stream specific or at minimum the NOx stream generated by the dissolution action of nitric acid would have to be scrubbed for removal of sulfur (or arsenic) compounds due to the negative effect of sulfur and/or arsenic compounds on the Ostwald catalyst.

Besides being sensitive to contamination by sulfur (or arsenic) compounds, the Ostwald process would require a substantial installation infrastructure added to the nitric acid process dissolution factory.

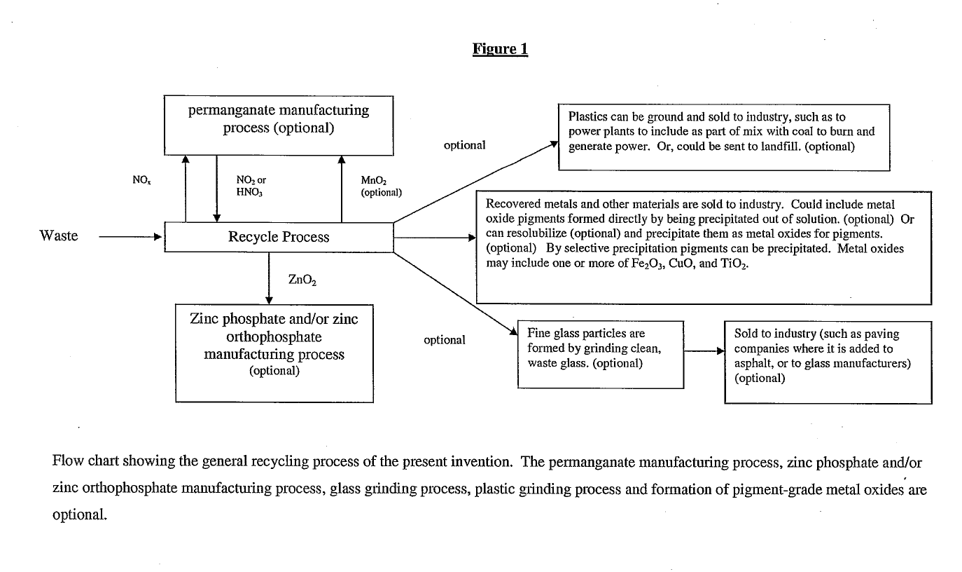

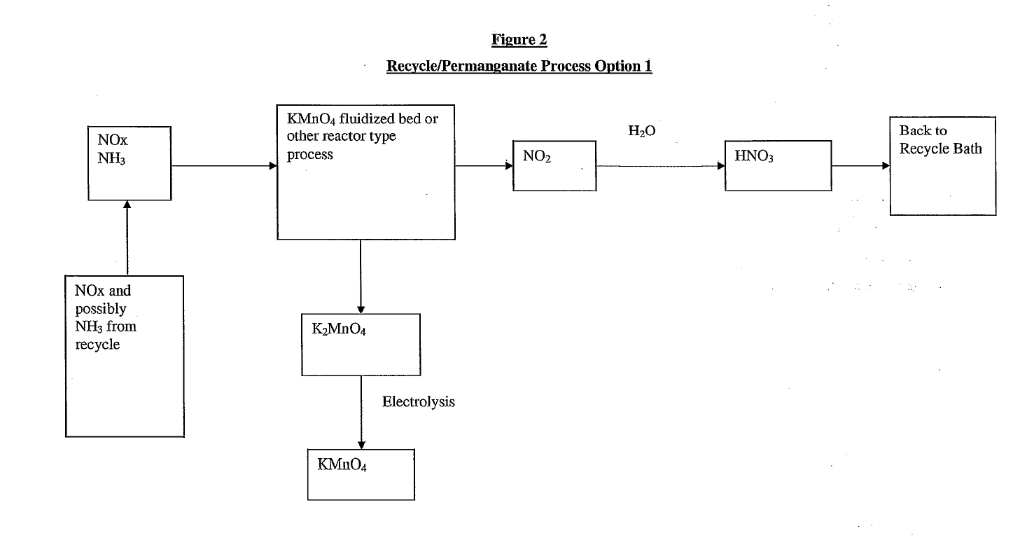

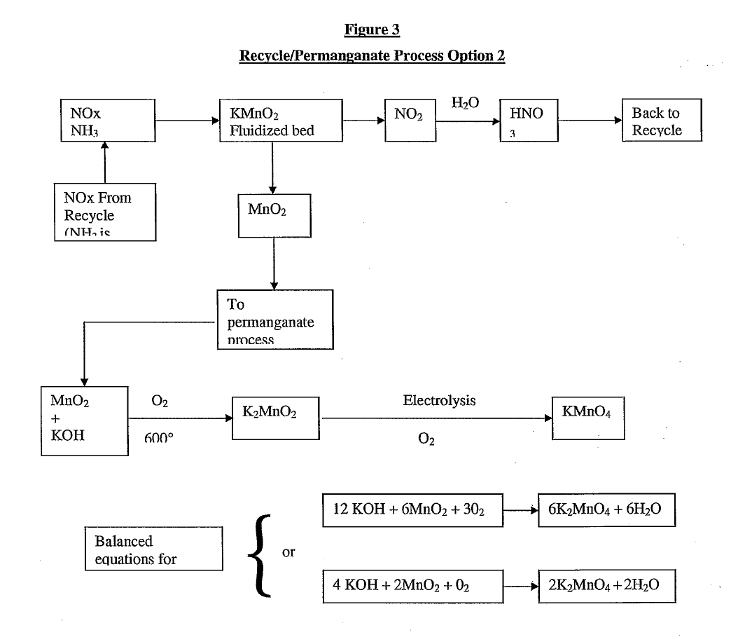

To circumvent the added cost of installing the Oswald process, the invention can also optionally include a permanganate process, either as part of or coupled to a process according to the invention. Such as process is illustrated in FIGS. 1-3.

There are two ways to use the materials from a permanganate plant to form NO₂ from NOₓ. The first is to use K₂MnO₄ (produced from MnO₂+KOH+O₂) in the permanganate process (K₂MnO₄ is cheaper than KMnO₄ and will oxidize NO to NO₂). The Ostwald process can be avoided by using K₂MnO₄ produced by the permanganate process:

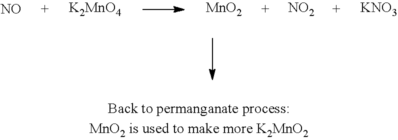

The KNO₃ generated from the above equation can be treated with H₂SO₄ to create more nitric acid and K₂SO₄, which can be used as fertilizer:

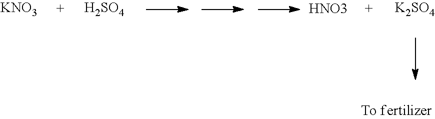

An alternate process to create permanganate is:

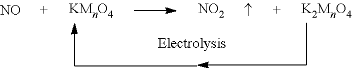

The NO₂ would then be dissolved in water to form nitric acid, which could be returned to the recycling process of the invention.

The highest cost processes in the recycle of batteries is the grinding and washing to remove electrolytes and other added compounds so the process can extract the valuable metals and metal oxides contain within. The washed and ground battery scrap is then extracted in nitric acid, dissolving all the metal and metal oxides except undischarged manganese dioxide which is not reacted and falls to the bottom of the leach tank. The undissolved manganese dioxide can be returned to the permanganate process as a starting raw material. The manganese nitrates and zinc nitrates contained in the leach solution can be precipitated as manganese dioxide and zinc oxide, which are used in the permanganate and water treatment industries respectively.

Sulfuric acid is a non-oxidizing leach acid used in some battery recycling. The issue with non-oxidizing mineral acids is that the metal compounds resulting are sulfides, sulfites, sulfates if sulfuric acid is used or chlorides if hydrochloric acid is used or phosphates if phosphoric acid is used which are metal compounds that are not starting materials for the chemical industry. All sulfides, sulfites, sulfates chlorides, phosphates have to be further processed to derive metal oxides and/or metal carbonates which are the starting materials for the chemical industry. Also non-oxidizing mineral acids leave a non-dissolved residue as not all metals are soluble in these mineral acids. Another issue with non-oxidizing mineral acids is that the dissolution of metals using such acids generates hydrogen. The acid is destroyed and cannot be reclaimed so the process continuously must be replenished with more acid and the hydrogen likely goes to waste. The process is not universally useful and it may be preferable financially to landfill rather than use non-oxidizing mineral acids for recycling.

The process of the invention avoids all or at least some of the above issues since it forms metal nitrates, which are soluble in nitric acid. Further, hydrogen is not released by nitric acid dissolution of metals (with only exceptions that are non-issues in e-waste). Therefore, the current invention forms metal nitrates and the resulting metal nitrate-containing solution can then be treated, if desired, to precipitate metal oxides and/or carbonates.

Metal oxides precipitated from the leach bath (as used herein, “leach bath,” “leach solution” and “mother liquor” each refer to a nitric acid bath including one or more metal nitrates) can, in many cases be sold as oxides, or can be heat treated to form pure metals. For example:

(1) AgO can be heated to get silver metal or alternately iron filings can be added to the leach bath and silver metal will precipitate. This is a redox reaction since iron is higher in the electromotive series than silver.
(2) CuO can be sold directly or alternately iron filings can be added to the leach solution and copper metal is precipitated as iron is more electromotive than copper.
(3) Fe₂O₃ can be sold directly and would be the first oxide recovered via pH shift of the mother liquor to a pH˜3 which would cause Fe₂0₃ to precipitate. Simple filtration would then separate the iron oxides from the solution.
(4) Lead and mercury can be precipitated via the injection of (NH₄)₂S beneath the surface of the liquid. Mercury and lead sulfides are insoluble and will precipitate from the leach bath. (NH₄)₂S or KHS brings down Mercury as HgS ↓ and lead as PbS ↓ or PbS ↓
(5) MnO₂ if alkaline or carbon/zinc batteries are recovered precipitates from the bath since MnO₂ is not dissolved by nitric acid unless it is in contact with a reducing agent such as iron metal or other anode metal. The MnO₂ would be present if the alkaline or carbon/zinc batteries are not fully discharged.

Overview of the current process for manufacturing permanganate:

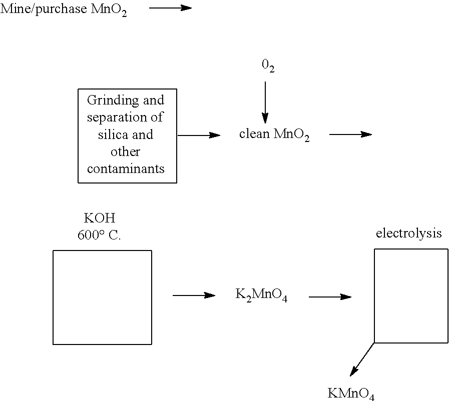

Whereas, a basic flow chart for an exemplary process according to the invention is as follows and is shown in FIGS. 1-3:

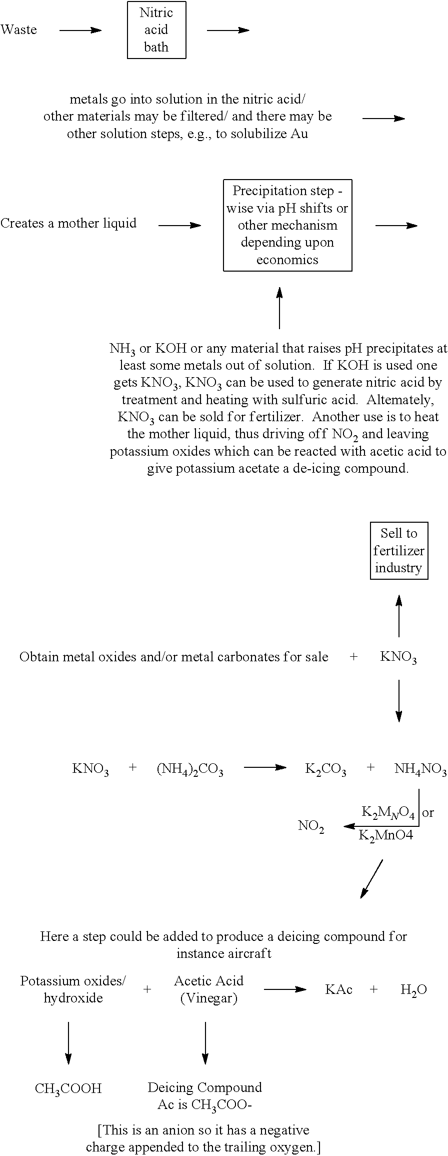

### Systems of the Invention

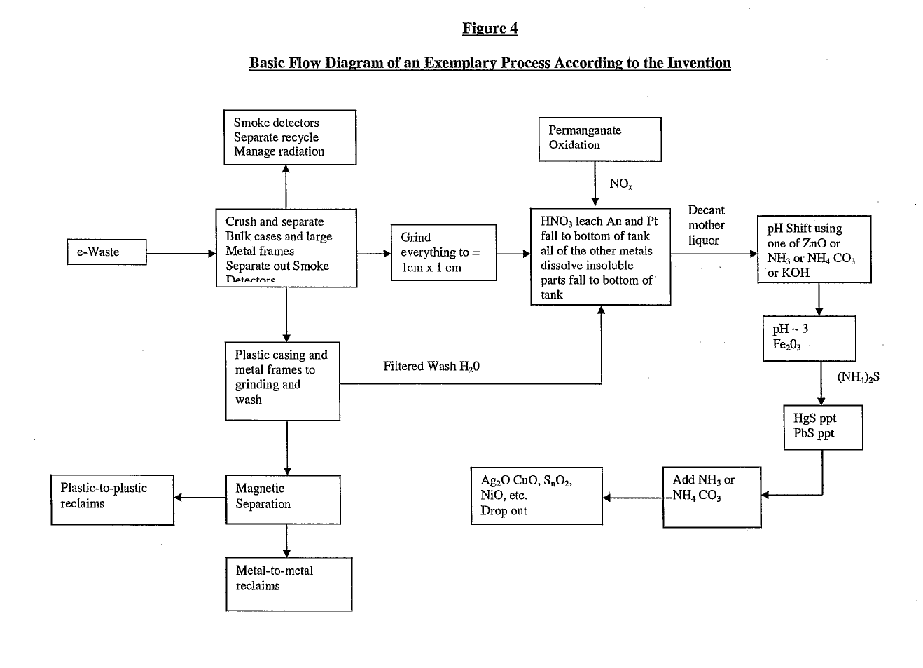

As shown in FIG. 4, system 2 is a block diagram illustrating four tanks (although any suitable number of tanks can be used). Nitric acid is in tank 1 and scrap is added to tank 1. The solution with dissolved metals can then be moved to different tanks and different metal oxides and/or metal nitrates can be precipitated and/or collected in different tanks. Further, metals that are not dissolved by nitric acid may be dissolved by the addition of other chemicals in tanks 1, 2, 3 and/or 4. Any method or system described herein could be a batch, continuous or semi-batch process.

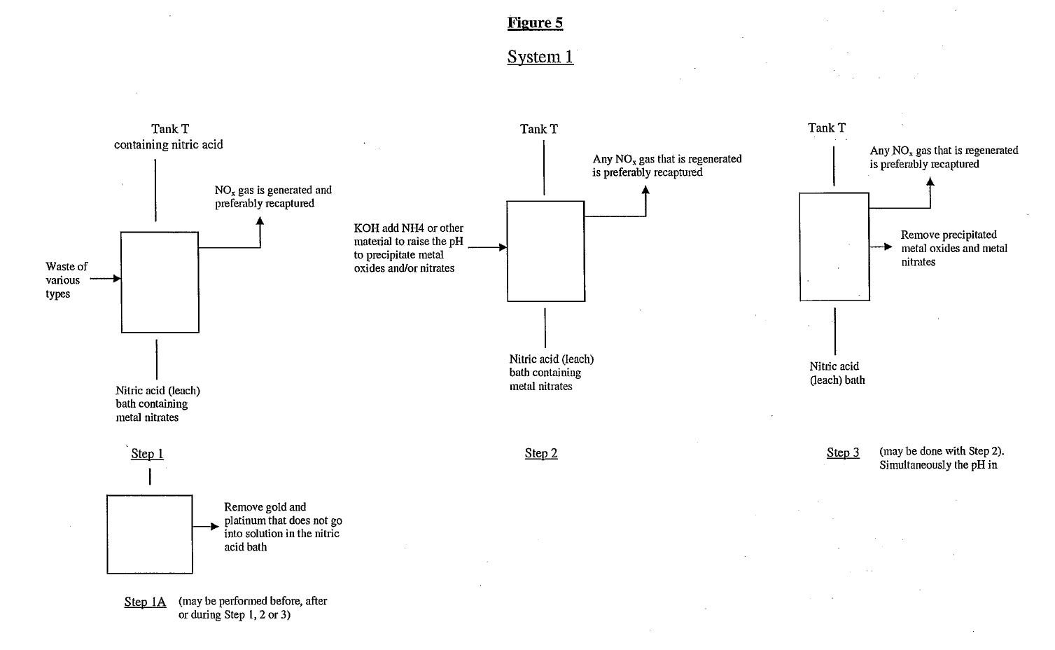

As shown in FIG. 5, system 3 is basically the same as system 2 except that different waste feeds are placed into different tanks. Since waste feeds are likely not pure in terms of metal content there would likely still be a need to precipitate different metal oxides and metal nitrates in different tanks.

Alternatively, a single tank could be used and the different metal oxides and metal nitrates could be precipitated at different times, or potentially at the same time if a convenient sorting method is used thereafter.

The process of destruction of the metal containing, metal oxide containing or nonmetal waste material generates nitrous oxides that are collected above the dissolution bath. The nitrous oxide is reoxidized to nitrogen dioxide which is dissolved in water resulting in nitric acid which is used to dissolve more waste material. The manganese oxides generated from the regeneration of nitric acid are returned to the permanganate process for manufacture of additional oxidant for regeneration of nitric acid. Alternately, potassium permanganate can be reduced to potassium manganage by NOx and then electrolytically reoxidized to the permanganate form. The zinc and manganese oxides (if batteries are included in the process) are sent to the permanganate process if they are manganese oxides and if zinc oxides are sent to become zinc chemicals used for water treatment facility protection and maintenance. A host of other uses exist for zinc compounds as well so this is not meant to be limiting on end uses of zinc compounds or manganese compounds or any material reclaimed.

Optionally, prior to the e-waste being placed into the bath certain components of the e-waste, such as plastic casings (for example, those that surround CRT monitors, desktop computers, casing around PC's, DVD's, TV's, and radios) could be removed. The separation will be preferably be mechanical via crushing the devices or otherwise gaining access to the interior and the broken casing will be rejected via magnetic separation or some other manner that does not include hand sorting.

The invention preferably utilizes a base to raise the pH in a nitric acid bath (for instance, KOH, NH₃, ZnO, etc. can all be used to increase pH) to precipitate metals that have been solubilized in the bath. If manganese oxides were present in the bath (for example, those present in spent battery cells) they would be recovered and sent for processing and be oxidized to K₂MnO₄ in KOH molten salt in the presence of oxygen in the process making permanganate as end product. Subsequent electrochemical oxidation would produce KMnO₄ (potassium permanganate) from potassium manganate.

The zinc compounds would be precipitated as zinc hydroxides. These can be subsequently processed into zinc oxides, zinc phosphates or any other zinc compound desired. The preferred goal would be to utilize the zinc compounds through added processing to manufacture zinc chemicals used in water treatment facilities or for water transport piping protection from bacterial growth. Passivation of water system infrastructure piping requires zinc compounds. There are many other uses for zinc metal and zinc compounds as well.

The mother liquor also contains metals from dissolution of electronic components such as silver, lead, tin, nickel, iron, mercury, arsenic, platinum, aluminum, indium, lanthanides such as lanthanum, prasodynium, neodinium, etc. All 3d, 4d, 5d and lanthanide metals and oxides are dissolved in nitric acid and would be present in the mother liquor. The mother liquor is treated by inorganic chemical processes to precipitate in succession the metals as oxides, carbonates or nitrates as desired. For instance iron present is precipitated as ferric oxide by raising the pH to approximately 3. Similar for all the other metals and lanthanides. Some metals may not be separated by choice, for example, the lanthanides, as these can be used in combined form in commerce.

Gold and platinum do not dissolve in nitric acid and these may be recovered from the bottom of the dissolution vessel as pure metal in many cases.

The fact that one can use spent alkaline and carbon/zinc batteries and make sodium or potassium permanganate is another aspect of the invention. Using the zinc obtained from spent alkaline or carbon/zinc batteries to manufacture water treatment zinc compounds are another of the aspects of the invention.

The reclamation of batteries on a large-scale basis, rather than just adding some to the process to increase the pH of the bath, would preferably be performed separately. The reason to treat batteries in a separate tank or process is because the metal values are more concentrated in batteries and the acid strength would have to be different, and the leaching characteristics of oxides (manganese oxides and zinc oxides) are different than for metal like copper, etc.

In a process according to the invention, the e-waste enters the breaking/crushing, sorting and concentration facility and is mechanically organized into materials that go directly to recycle in plastics, aluminum metal casing, plated steel casing and so forth to the extent economically feasible. It may be required to first clean the e-waste, and that can be done in any suitable manner, such as by using a wash bath and use the wash water in the nitric recycle so dirty water or waste water is not generated. The concentrated metal-containing e-waste (printed circuit boards, wire bundles, disc drives, crushed monitors, crushed flat panel displays, radio parts, etc.) is ground into pieces preferably not more than a centimeter on any side. This is then fed into the nitric acid bath. Nitric acid is very aggressive and dissolves copper, silver, tin, and finely divided iron, and other metals. Mercury, lead, and the 5d transition metals are not so active and will take longer to dissolve.

The nitrous oxides from the primary leach bath will preferably be continuously decanted from the leach bath, nitric acid will be re-added and the leach bath stirred as needed. Stirring can be done via atmospheric air pumped into the bath beneath the liquid from the bottom or any other suitable method. The process and system may be closed with hoods over the leach tank(s) such that the nitrous oxides are captured in a gas handling system. The nitrous oxides could then be lead via a gas-handling system into a reactor bed containing moist basic potassium manganate (or permanganate), where the nitrous oxide is oxidized to nitrogen dioxide. The nitrogen dioxide would then be moved into a water bath where it would dissolve and react with water to form nitric acid. In the manganate/permanganate reactor bed manganese dioxide may be created as a result of the oxidation/reduction of the process. This manganese dioxide may optionally be returned to the permanganate process (if included) for making more manganate/permanganate, which can make the process more cost effective.

The Ostwald process for generation of nitric acid starts with ammonia that is oxidized to nitrogen dioxide using a noble metal-containing catalyst. The production of nitric acid is linked to ammonia production. The Haber Process is used to manufacture ammonia from nitrogen. Ammonia is the raw starting material for the Ostwald Process. The manufacture of nitric acid is nearly always coupled to and on the same site as the manufacture of ammonia process. The Haber process can be used to feed the Ostwald Process for the manufacturing of nitric acid. In the presently-described process, there is no need to install the Ostwald process, with its associated problems of high temperature reaction of oxygen with nitrogen oxides to form nitrogen dioxide over a noble metal catalyst. The presently described process using potassium manganage/potassium permanganate is generally applicable and much simpler. Also oxygen, which is required in the Oswald process, is difficult to utilize in molecular form from the atmosphere. If the process of the invention includes or is coupled to a permanganate generation process, one potential benefit is the regeneration of nitric acid from the nitrous oxides collected from the leach bath, wherein the nitric acid is regenerated using the output from the permanganate process. This helps make recycle process environmentally friendly and sustainable because all or most things from the process are reclaimed. Additionally, it should lower the costs for each process.

The fact that batteries may optionally be included as waste or reclaimed in a separate system using the same process could add further benefits. The increased metal values in batteries helps the recycle process according to the invention obtain more reclaim from the tonnage as batteries have a greater percentage of metal than other e-waste and the zinc and manganese dioxide and manganese oxide reclaimed from battery recycling using the invention optionally goes to a permanganate process as a raw material feed stock.

The reclamation is green by recycling and reusing things that have not been previously and because it generates raw materials that are precursors to needed chemicals for the (optional) permanganate process and the reclamation process itself. The fact that batteries can optionally be a raw material feed stock once recycled is a benefit that is a surprise but only so because manganate/permanganate to regenerate its solvent nitric acid.

The non-metal waste, such as plastic, sheet metal, glass (from CRT's, fluorescent tubes, etc.), Teflon insulation on the copper wires, will be essentially clean of metals. This material can be reused in the appropriate industry or disposed. For example, ground clean glass can be used for the filling of potholes and repaving roads.

Au and Pt are not dissolved (unless a solution other than or in addition to nitric acid is used), but fall to the bottom of the leach bath. They can then be collected from the bottom of the tank containing the leach bath or can be solubilized using aqua regia, and later be precipitated.

A process and system according to the invention may be batch, semi-batch or continuous. For example, the metals may be dissolved in one tank and precipitated in another, or different metals could be dissolved in different tanks and/or different metals could be precipitated in different tanks.

Having thus described some embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

What is claimed is:

1. A process for separating metal from waste, the process comprising the steps of:
(a) placing the waste including one or more metals into a bath comprising nitric acid, at least one of the one or more metals becoming soluble in the nitric acid to create a solution;
(b) precipitating the one or more metals that became soluble in the nitric acid bath from the solution as either a metal oxide or a metal nitrate.

2. The process according to claim 1 wherein the waste includes more than one metal and wherein all of the metals go into solution.

3. The process according to claim 1 wherein the waste includes more than one metal and wherein not all of the metals go into solution.

4. The process of any of claim 1 wherein the one or more metals are selected from one or more of the group consisting of: silver, gold, platinum, copper, zinc, tin, iron, mercury, antimony, arsenic, calcium, nickel, cadmium, beryllium, rhodium, palladium, lead, aluminum, magnesium, manganese, indium and iridium.

5. The process according to claim 1 wherein the metal could also be precipitated as an elemental metal and wherein the metal that is precipitated as an elemental metal is selected from one or more of the group consisting of copper, silver, gold and platinum.

6. The process according to claim 1 that further comprises the step of physically separating at least some of the non-metal components of the waste from the one or more metals prior to placing the waste including the one or more metals into the bath.

7. The process according to any of claims 1-6 wherein the waste includes non-metal components and at least some of the non-metal components are separated prior to placing the waste including one or more metals into the nitric acid bath.

8. The process according to any of claims 1-6 wherein at least some of the non-metal components are separated after placing the waste including one or more metals into the nitric acid bath.

9. The process of any of claims 1-8 wherein the one or more metals are precipitated by increasing the pH of the nitric acid bath.

10. The process of claim 9 wherein the pH is increased by adding potassium hydroxide to the nitric acid bath.

11. The process of claim 9 wherein the pH is increased by adding ammonia to the nitric acid bath.

12. The process of claim 9 wherein the pH is increased by adding zinc oxide to the nitric acid bath.

13. The process of claim 12 wherein the zinc oxide is added to the nitric acid bath by adding waste alkaline batteries that include zinc oxide.

14. The process of claim 9 wherein the pH is increased by adding potassium carbonate to the nitric acid bath.

15. The process of claim 9 wherein the pH is increased by adding (NH₄)₂CO₃ to the nitric acid bath.

16. The process of any of claims 1-15 wherein each of the at least one metal is precipitated from the solution by progressively increasing the pH of the nitric acid bath and removing each metal individually when it precipitates.

17. The process of claim 10 wherein a by-product of adding potassium hydroxide to the nitric acid bath is potassium nitrate.

18. The process of claim 17 wherein the potassium nitrate is separated from the nitric acid bath.

19. The process of claim 3 wherein one of the one or more metals is gold and gold does not go into solution in the nitric acid bath.

20. The process of claim 3 that further includes the step of solubilizing at least one of the one or more metals that is not soluble in the nitric acid bath.

21. The process of claim 20 wherein the one of the one or more metals that is not solubilized in the nitric acid bath is gold and the gold is solubilized by adding aqua regia or mercury to the nitric acid bath.

22. The process of any of claims 1-21 wherein at least one of the one or more metals precipitated is converted to an elemental metal after being precipitated.

23. The process of claim 22 wherein the at least one metal converted to an elemental metal is done so by heating the metal oxide or metal nitrate.

24. The process of claim 23 wherein the at least one metal converted to an elemental metal is selected from the group consisting of copper, silver, gold and platinum.

25. The process of any of claims 22-24 wherein the precipitated metal is converted to elemental metal by heating it in the presence of hydrogen.

26. The process of claim 25 wherein the hydrogen is mixed with nitrogen.

27. The process of any of claims 1-26 that further includes the step of obtaining waste by offering a rebate to persons that possess waste, wherein a person receives the rebate upon sending the waste to a designated location.

28. The process of any of claims 1-27 wherein the waste is one or more of the group consisting of: batteries, lap-top computers, fluorescent light bulbs, cameras, desk-top computers, television, DVD players, cell phones, CD players and radios.

29. The process of claim 1 wherein the waste is e-waste.

30. The process of any of claims 1-11 and 16-29 wherein potassium hydroxide is used to raise the pH of the nitric acid bath, at least one of the one or more metals is manganese and one of the hi-products from dissolving the manganese in the nitric acid bath and precipitating it using potassium hydroxide is MnO₂.

31. The process of claim 30 wherein the MnO₂ is used to make permanganate.

32. The process of any of claims 10, 30 and 31 wherein the KOH is provided by adding waste alkaline batteries to the nitric acid bath.

33. The process of any of claims 1-32 that includes multiple baths of nitric acid.

34. The process of any of claims 1-33 wherein at least one nitric acid bath is agitated.

35. The process of claim 34 wherein at least one nitric acid bath is agitated as the waste is being added.

36. The process of any of claims 1-35 wherein at least one nitric acid bath is heated.

37. The process of any of claims 1-36 wherein the waste is crushed before being added to the nitric acid bath.

38. The process of claim 5 that further includes the step of adding iron in the form of shavings.

39. The process of any of claims 1-38 wherein the waste is separated into different categories according to the metal content of the waste prior to placing the waste including one or more metals into the nitric acid bath.

40. The process of any of claims 27-29 wherein each different type of waste is sent to a different designated location.

41. The process of claim 40 wherein the categories are one or more of the group consisting of: batteries, lap-top computers, desk-top computers, fluorescent lights, cameras, desk-top computers, television and radios.

42. The process of any of claims 1-41 that includes a first tank for holding the nitric acid bath and into which the waste including one or more metals is added, and a second tank in which the at least one of the one or more metals is precipitated.

43. The process of claim 42 wherein there are multiple tanks for precipitating metal from the solution.

44. The process of claim 43 wherein different metals are precipitated from each of the multiple tanks for precipitating metal.

45. The process of each of claims 43-44 wherein each of the multiple tanks has a pH different from each of the other multiple tanks for precipitating metal.

46. The process of any of claims 1-45 that is continuous.

47. The process of any of claims 1-45 that is semi-batch.

48. The process of any of claims 1-45 that is batch.

49. The process of claim 35, 39, 40, 41, 42 or 43 wherein the equipment can also be used to recover nitric acid.

50. The process of any of claims 1-49 wherein gold is recovered from the bottom of the tank in which the waste including one or more metals is placed.

51. The process of claim 31 that further includes a process for generating permanganate wherein the MnO₂ is used as a raw material for generating permanganate.

52. The process of any of claims 1-51 wherein NOₓ gas is produced as a by product.

53. The process of claim 52 wherein the NOₓ gas is used as a raw material for generating permanganate.

54. The process of any of claims 1-52 wherein the nitric acid is formed by mixing water with NO₂ and the NO₂ is a by product of a permanganate manufacturing process.

55. The process of any of claims 1-51 wherein ZnO₂ is generated.

56. The process of claim 55 wherein the ZnO₂ is used as a raw material in the production of one or more of zinc phosphate and zinc orthophosphate.

57. The process of any of claims 1-54 wherein scrap plastic is generated.

58. The process of claim 57 wherein the scrap plastic is ground into relatively small pieces.

59. The process of claim 57 or claim 58 wherein the scrap plastic is mixed with coal and the mixture is used as fuel.

60. The process of claim 59 wherein the mixture is used as fuel to generate electricity.

61. The process of claim 59 or 60 wherein the weight percentage of scrap plastic in the mixture is between 1% and 40%.

62. The process of claim 59 or 60 wherein the weight percentage of scrap plastic in the mixture is between 5% and 30%.

63. The process of claim 59 or 60 wherein the weight percentage of scrap plastic in the mixture is 25% or less.

64. The process of claim 59 or 60 wherein the weight percentage of scrap plastic in the mixture is 10% or less.

65. The process of any of claims 1-64 wherein scrap glass is recovered.

66. The process of claim 65 wherein the scrap glass is ground into fine particles.

67. The process of claim 66 wherein the fine particles of scrap glass are used as aggregate to make asphalt.

68. The process of any of claims 1-67 wherein metal oxides are formed.

69. The process of claim 68 wherein at least one of the metal oxides is sold as a pigment.

70. The process of claim 69 wherein at least one of the metal oxides is resolubilized and then precipitated as a pigment.

71. The process of any of claims 68-70 wherein the metal oxides include one or more of the group consisting of Fe₂O₃, CuO and TiO₂.

72. A process for reclaiming metal from waste, the waste having been concentrated at a given location, the waste including one or more of silver, aluminum, copper, lead, gold, bismuth, arsenic, mercury, and the process including the steps of:
separating the e-waste;
cleaning the e-waste;
dissolving at least some of the metal to create a solution; and
precipitating the metal as a metal oxide or metal nitrate.

73. The process of claim 72 wherein the pH of the solution is increased by adding KOH obtained from primary or secondary batteries containing KOH as electrolyte.

74. The process of any of claims 72-73 wherein metal, such as copper, silver, gold, or platinum, is precipitated as the metal by addition of a more electropositive material to the nitric acid bath.

75. The process according to claim 72 wherein the waste includes more than one metal and wherein all of the metals go into solution.

76. The process of any of claims 1-12 wherein the metals are selected from one or more of the group consisting of: silver, gold, platinum, copper, zinc, tin, iron, mercury, antimony, arsenic, calcium, nickel, cadmium, beryllium, rhodium, palladium, lead, aluminum, magnesium, manganese, indium and iridium.

77. The process of any of claims 72-76 wherein at least one metal is precipitated by increasing the pH of the solution.

78. The process of any of claims 1-19 and 27-38 wherein potassium hydroxide is used to raise the pH of the nitric acid bath, at least one of the one or more metals is manganese and one of the byproducts from dissolving the manganese in the nitric acid bath and precipitating it using potassium hydroxide is MnO₂.

79. The process of claim 78 wherein the KOH is provided by adding waste alkaline batteries to the nitric acid bath.

80. The process of any of claims 1-79 that includes multiple baths of nitric acid.

81. The process of any of claims 1-79 wherein at least one nitric acid bath is agitated.

82. The process of claim 81 wherein at least one nitric acid bath is agitated as the waste is being added.

83. The process of any of claims 1-82 wherein at least one nitric acid bath is heated.

84. The process of any of claims 1-82 wherein the waste is crushed before being added to the nitric acid bath.

85. The process of claim 84 wherein the categories are one or more of the group consisting of:
batteries, lap-top computers, desk-top computers, fluorescent lights, cameras, desk-top computers, television and radios.

86. The process of any of claims 1-85 that includes a first tank for holding the nitric acid bath and into which the waste including one or more metals is added to create a solution, and a second tank in which the at least one of the metals is precipitated from the solution.

87. The process of claim 86 wherein there are multiple tanks for precipitating metal from solution.
